(19) United States
(12) Patent Application Publication
(10) Pub. No.: US 2024/0399971 A1
(43) Pub. Date: Dec. 5, 2024

(54) Sport Equipment Mount for Pickup Trucks

(71) Applicant: Matthew R. Murray, Slatington, PA (US)

(72) Inventor: Matthew R. Murray, Slatington, PA (US)

(21) Appl. No.: 18/203,745

(22) Filed: May 31, 2023

(51) Int. Cl. B60R 9/08

(52) U.S. Cl. CPC B60R 9/08

(57) ABSTRACT

A sport equipment rack for mounting onto a vehicle load bed side wall having a plurality of mounting post holes located within the side walls having a vertically distending shaft. The sport equipment rack having a mount with a support plate and a distending rectangular shaft dimensioned to fit within and be supported in a vertical orientation by a selected mounting post hole also including an inwardly angled upwardly extending rectangular shaft for supporting and retaining one or more sport equipment holders. The sport equipment rack mount can be locked in position within the mounting post holes. Sport equipment can be mounted to and removed from paired adjacent sport equipment holders by a sport equipment user standing at ground level.

### BACKGROUND OF THE INVENTION

The present invention resides in the field of sport equipment mounting apparatus that can be mounted, retained, and locked in place onto a sidewall of a pickup truck.

During a camping trip with friends and family my truck was loaded almost beyond capacity (volume not weight) with sports equipment, i.e., 2 kayaks, gear bags, 4 bicycles, and food and drink storage containers. All the items were stowed either in the load bed of the truck or on the truck with the help of a trailer hitch bike rack. It was important to be able to operate the truck with the tailgate closed in order to accommodate the bike rack. Later in the year when picking up my snowboard from a tune shop, it was tossed into the load bed as most people do who own pickup trucks. It was opportune that there was no snow or debris in the load bed at the time. However, the board, not being secured in a desired position or location, merely banged around as the pickup truck was driven around. Looking into this further, various racks for trucks for sporting equipment were reviewed, but just about all of the available racks either impeded the tailgate or reduced the cargo space in the load bed as the racks span across the top of the load bed in a fashion similar to a car roof rack. The only option then available was to mount ski rack attachments to the contractor style ladder rack system increasing the vehicle overall height and exposing the sporting equipment to debris from vehicle forward movement. Also, the mounting and dismounting of the sporting equipment was possible mainly from only the load bed of the pickup truck and not from the ground at the side of the truck. All of the various options were also expensive.

While contemplating a possible mounting system, it was noted that the post holes in truck beds were not used to any great extent. This failure of use seemed to be a waste of a very handy feature of every pickup truck bed from every truck manufacturer. A rack system utilizing these post holes would not only free up space in the load bed for larger and/or dirtier cargo but would also allow for easier access to snowboards (as well as other recreational gear) from the truck side especially on lifted trucks. This would be especially handy for those who go back-country skiing/riding and have their sleds and other gear in the bed of the truck. Also, for people camping with ATVs and kayaks, etc., and don't want to use a trailer. There are a multitude of options and scenarios where a side mounted and accessed rack system would be very handy.

It is therefore an object of the present invention to provide a side-mounted rack system, accessible from the ground, onto a sidewall of a truck to allow for the mounting of sport equipment while maintaining storage for larger, heavier items in the load bed. It is a further object of the present invention to provide anti-theft devices to retain the rack system in position on the truck side rail. It is a still further object of the present invention to angle the rack system inwardly to prevent exposure of the sport equipment to debris and wind wear while travelling. It is an additional object of the present invention to create a rack system that is modifiable to permit a greater number of racks on a single mounting position. Other objects will appear hereinafter.

### SUMMARY OF THE INVENTION

What came about is a rack system that would suit these purposes in a stripped down, simplistic yet versatile format, making it easy to use, easy to store in the cab when not in use, capable of use for a multitude of attachments, all at a lower cost option to what is currently available on the market today. What was developed is a simple hollow post made of rectangular steel tubing with threaded holes on opposite sides and an additional threaded hole on the bottom for hand knobs to secure it to a post hole in the truck bed. Welded on top of that rectangular steel tubing is a steel base plate that has high density foam affixed to the underside to cushion contact with the truck bed. Welded atop the base plate is a short or extended length rectangular steel tube, inclined inwardly at a 45° angle, so when a snowboard rack is attached to the angled tube of the mounting system the result is the board clamped on its side is in a vertical orientation. For sponsored and pro snowboarders this makes their boards moving billboards, without impeding cargo space in the truck bed, or blocking the tailgate at all.

A sport equipment rack for mounting onto a vehicle load bed side wall includes a plurality of mounting post holes located within the side walls and having a vertically distending shaft within the side walls and a sport equipment rack mount having a support plate with a distending rectangular shaft dimensioned to fit within and be supported in a vertical orientation by a selected mounting post hole. The sport equipment mount also includes a rectangular shaft inwardly angled and upwardly extending from the mounting plate for supporting and retaining one or more sport equipment holders. The sport equipment rack mounts are positioned in desired mounting post holes in pairs depending upon the length of the sport equipment being transported. Selected sport equipment can be mounted to and removed from paired adjacent sport equipment holders by a sport equipment user standing at ground level.

The sport equipment rack can also include an extension to the inwardly angled upwardly extending rectangular shaft for supporting and retaining additional sport equipment holders. The extension of the inwardly angled upwardly extending rectangular shaft for supporting and retaining additional sport equipment holders allows for one or more additional sport equipment holders to be mounted to the extending rectangular shaft. The inwardly angled upwardly extending rectangular shaft is preferred to have an inward angle of 45° such that the sport equipment held by the sport equipment mount can travel at a substantially vertical orientation.

The sport equipment rack further includes one or more locking mechanisms paired with corresponding sport equipment mounts and mounting post holes that threadedly retain the sport equipment mount within the mounting post hole and guard against removal of the sport equipment mount with locking knobs preventing such removal. The sport equipment mount locking knobs connect through the sport equipment mount and the mounting post hole from a forward facing side to a rearward facing side. The sport equipment mount can include an additional locking knob to connect the sport equipment mount and the mounting post hole from the mounting post hole bottom being threadedly connected through a hole in the post hole bottom into the sport equipment mount.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of a pickup truck with two of the sport equipment mounts of the present invention mounted onto a sidewall of the pickup truck load bed.

FIG. 2 is a partial cross-section perspective view of the sport equipment mount of the present invention showing the lower section mounted through a sidewall of the pickup load bed sidewall and the upper section sport equipment mount exploded away from the attachment bar of the lower section.

FIG. 3 is a cross-sectional exploded view of the lower section of the sport equipment mount of the present invention with a short attachment bar to be positioned within a mounting aperture of a sidewall of the load bed of a pickup truck.

FIG. 4 is a sectional view of the present invention taken along Line 4-4 of FIGS. 2.

FIG. 5 is a side view of a short attachment bar of the lower section of the sport equipment mount of the present invention.

FIG. 6 is a side view of a longer lower attachment bar and an extended attachment bar threadedly attached to the lower attachment bar of the sport equipment mount of the present invention.

FIG. 7 is a partially cutaway cross-sectional view of the sport equipment mount of the present invention showing the lower section mounted through a post hole of the pickup load bed sidewall and the upper section sport equipment mount with an extended attachment bar.

FIG. 8 is an exploded cross-sectional view of the lower section of the sport equipment mount of the present invention to be positioned within a mounting aperture of a sidewall of the load bed of a pickup truck.

FIG. 9 is a sectional view of the present invention taken along Line 9-9 of FIG. 7.

FIG. 10 is a sectional view of the present invention taken along Line 10-10 of FIG. 9.

### DETAILED DESCRIPTION OF THE PREFERRED EMBODIMENTS

The following detailed description is of the best presently contemplated mode of carrying out the invention. The description is not intended in a limiting sense and is made solely for the purpose of illustrating the general principles of the invention. The various features and advantages of the present invention may be more readily understood with reference to the following detailed description taken in conjunction with the accompanying drawings.

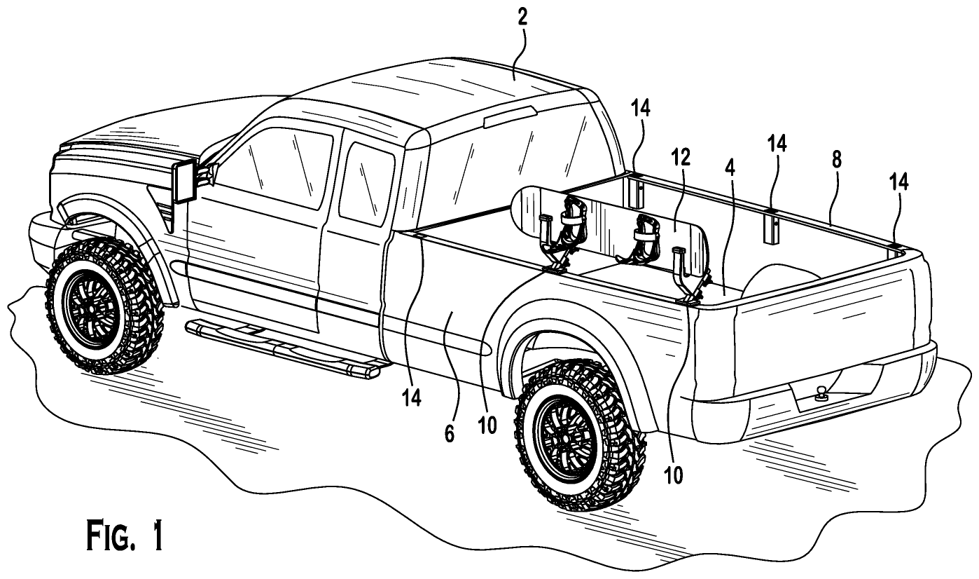

Referring now to the drawings in detail, where like numerals refer to like parts or elements, there is shown in FIG. 1 a pickup truck 2 having a load bed 4 and right and left sidewalls 6, 8. Mounted to the left sidewall 6 are a pair of sport equipment mounts 10 holding and suspending in a vertical orientation an item of sport equipment, e.g., a snowboard 12. It is to be noted that pickup trucks 2 can have a varied number and placement of sidewall post holes 14. As shown in the pickup truck 2, the post holes 14 are three in number along each sidewall 6, 8. FIG. 1 shows forward and rearward post holes along each sidewall 6, 8 and a third post hole positioned along each sidewall toward the midpoint of the length load bed 4. There could also be four post holes, or the middle post hole positioned closer to the forward or to the rearward post hole.

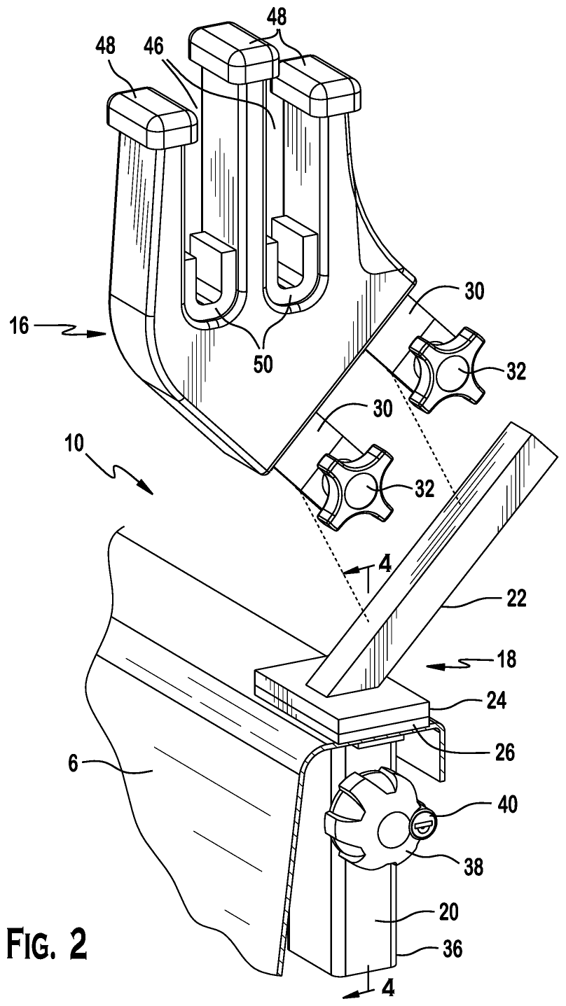

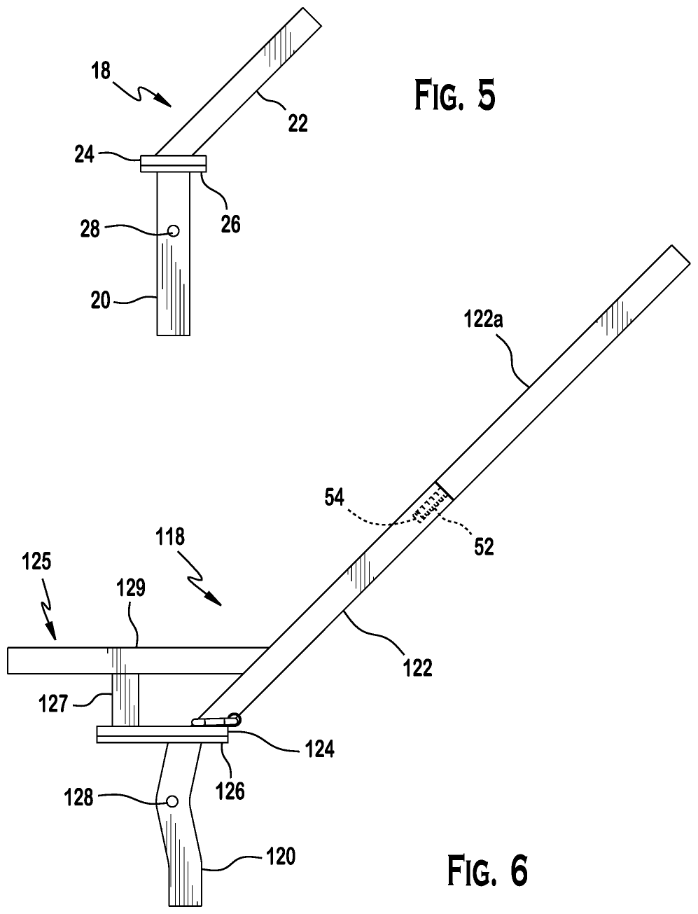

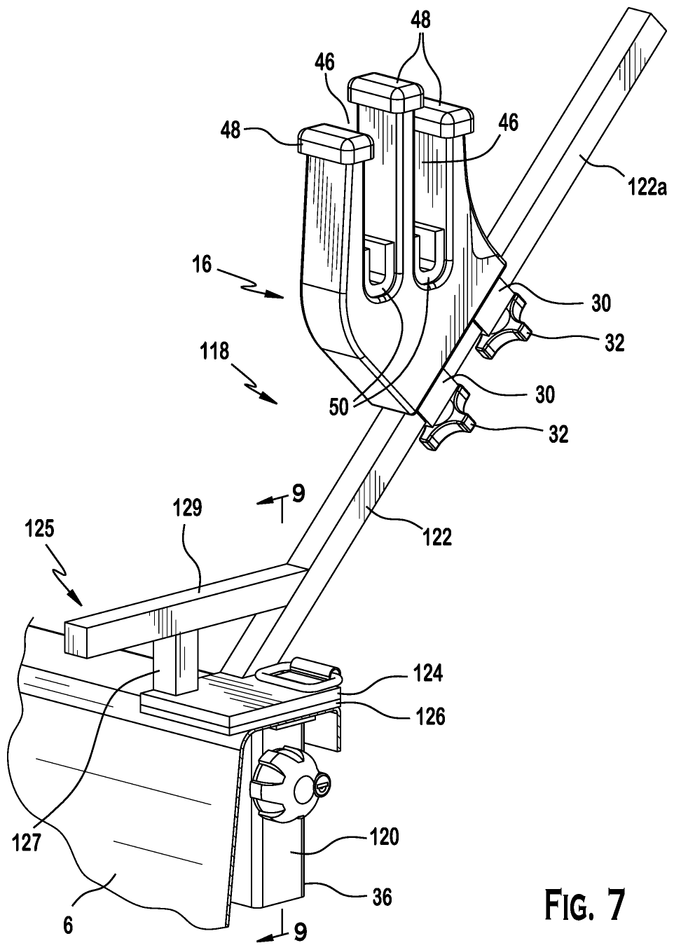

FIG. 2 shows that each sport equipment mount 10 includes both an upper section 16 for holding and securing an item of sport equipment 12 and a lower mounting section 18 for securing the entire assembly to the sidewall 6, 8 of the pickup truck 2. The lower mounting section 18 of the short length sport equipment mount 10 is better seen with reference to FIG. 5. The lower mounting section 18 has a hollow vertical post 20 and an inwardly angled hollow post 22 for mounting the upper section 16. The inward angle of the mounting post 22 is preferred to be 45° for the reason that this will provide for a vertical travel angle for the sport equipment 12, but may be any other convenient angle. Each of the vertical posts 20 and the angled mounting posts 22 have a rectangular cross-section and are joined together by welding to flat plate 24. A square piece of a cushioning and protecting foam or pliable plastic, such as Styrofoam 26, is positioned immediately beneath the flat plate 24 surrounding the vertical post 20 to cushion against and prevent damage to the truck body sidewall 6, 8 when securing the sport equipment mount 10 the truck body. Also included in the vertical post 20 is a through hole 28 used in securely affixing the sport equipment mount 10 to the truck body sidewall 6, 8.

Referring back to FIG. 2, the lower mounting section 18 is shown positioned through a post hole 14 of the left sidewall 6 of the pickup truck 2. The rectangular vertical post 20 and the corresponding rectangular hollow of the post hole 14 maintain the sport equipment mount 10 in an orthogonal relationship to the pickup truck side wall 6 such that the upper angled mounting post 22 is angled perpendicularly inward over the pickup truck load bed 4. Once the vertical post 20 is secured to the truck body the upper section 16 of the sport equipment mount 10 can then be mounted to the lower mounting section 18 by means of a pair of clamps 30 and tightening knobs 32 that clamp inwardly onto the angled mounting post 22 to securely retain the upper section 16 in the desired position along the length of the angled mounting post 22.

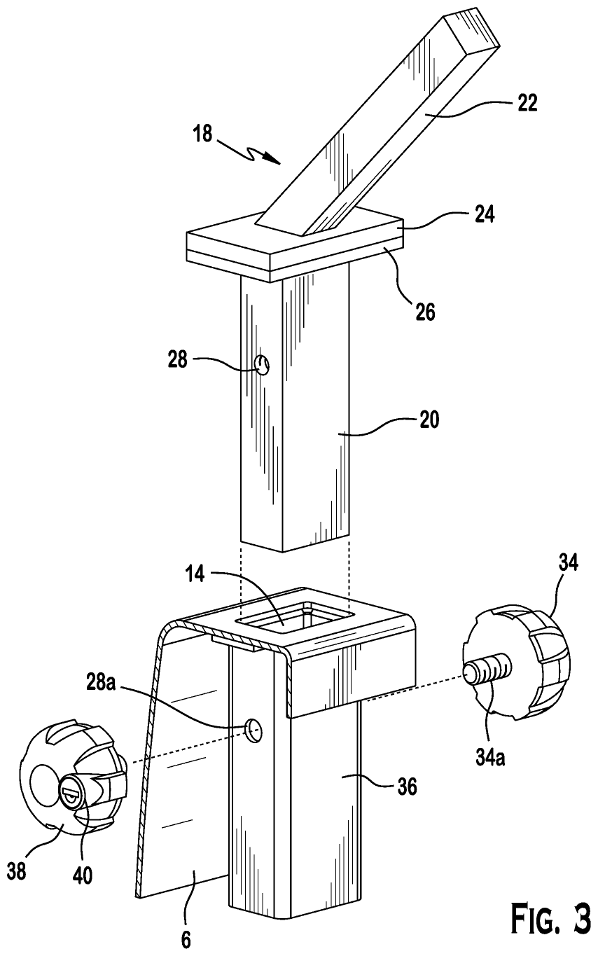

As shown in FIG. 3, to properly secure the vertical post 20 of the lower mounting section 18 of the sport equipment mount 10 into the post hole 14 a threaded knob 34 is inserted into positionally cooperative through hole 28a passing through the post hole wall 36 from front to back and through hole 28 of vertical post 20. The threaded post 34a on the inward facing side of threaded knob 34 extends through both cooperating through holes 28, 28a and threadedly attaches to cooperating locking rear knob 38. Locking rear knob 38 has a keyway 40 used for locking the knob 38 against turning so as to guard against release or withdrawal of the vertical post 20 from the post hole 14 once secured and locked in position.

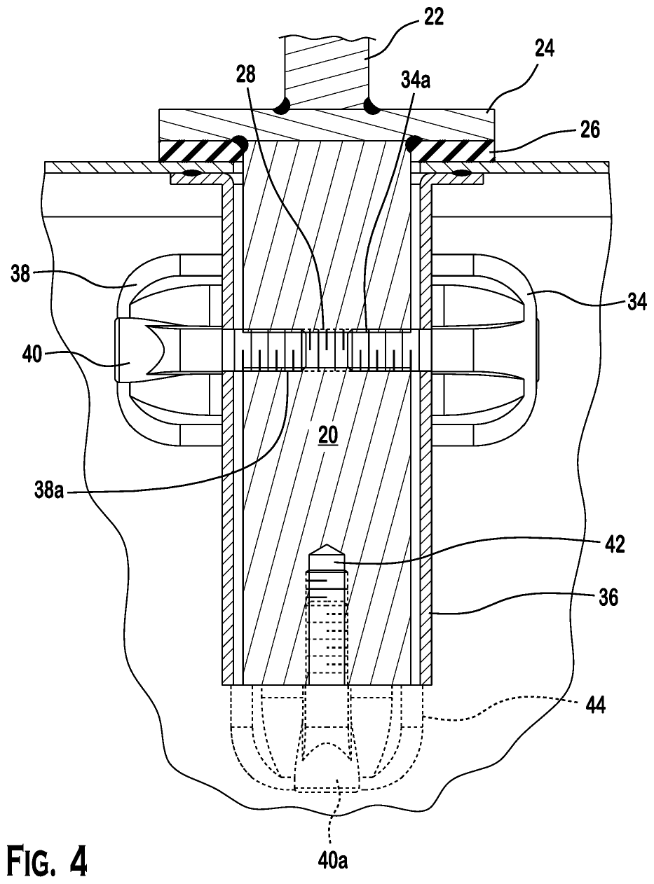

Alternatively, the through hole 28 of a solid rectangular vertical post 20 can be threaded to accommodate the threaded extensions 34a, 38a of each of the securing knobs 34, 38. See, FIG. 4. Securing knob 38 will still maintain the keyway for locking the knob 38 against turning to prevent removal of the vertical post 20 from the post hole 14. Further, the vertical post 20 may be alternately, or additionally secured into the post hole 14 by a bottom threaded hole 42 by an additional securing knob 44 and locking keyway 40a to prevent extraction of the lower mounting assembly, i.e., the vertical post 20, from the post hole 14 of the truck body.

Returning again to FIG. 2, the upper section 16 of the sport equipment mount 10 has at least one vertically oriented upwardly opening mounting slot 46 for accommodating a number of different sport equipment 12 such as for winter sports, e.g., snowboards, skis or larger sport equipment, and for summer sports, e.g., skateboards or surfboards. In the present example there are two parallel slots 46 that have upper and lower cushions 48, 50, respectively, for assisting in retaining and guarding against damage to any carried sport equipment 12.

In the event that a much greater number of sport equipment 12 are desired to be carried than slots 46 can manage, another upper section 16 can be mounted to the angled mounting post 22. If this is insufficient, then an extended length of the angled mounting post can accommodate such additional equipment by providing additional angled mounting post space. Referring to FIG.

6, there is shown an extended length lower mounting section 118. The extended lower mounting section 118 has a vertical post 120 extending downward and an inwardly angled post 122 for mounting one or more upper sections 16. The inward angle of the mounting post 122 is preferred to be 45° for the reason that this will provide for a vertical travel angle for the sport equipment 12, but may be any other convenient angle. An extended length mounting post 122a can be added to the mounting post 122 by threaded engagement between the two like shaped rectangular cross-sectional posts 122, 122a. Extended length mounting post 122a is preferred to have a threaded extension rod 52 on its lower end that cooperatively threads into a threaded hole 54 at the uppermost end of the mounting post 122 having a greater depth than the length of the threaded rod 52.

Each of the vertical posts 120 and the angled mounting posts 122 are joined together by welding to flat plate 124. In order to support the extended length mounting post 122a, a brace 125 is added to retain the mounting post 122 in its desired angular relationship to the flat plate 124 and prevent wear on the weld through use and exposure to weather. The brace 125 includes a vertical post section 127 and a horizontal extension arm section 129 that are welded together at right angles at the approximate mid-point of the extension arm section 129. The vertical post section 127 and the extension arm section 129 are then welded to the flat plate 124 and to the mounting post 122, respectively. In the example shown, the mounting post 122 and the brace 125 are welded off-center along the forward edge of a larger dimensioned flat plate 124 but the vertical post 120 is welded at the center of the flat plate 124 along its bottom side. The larger dimensions in both length and width of the flat plate 124 is to offset any forces to destabilize the lower mounting section 118 due to load weight of the sport equipment 12.

As in the case of the lower mounting section 18, a square piece of protective foam or pliable plastic, such as Styrofoam 126 dimensioned the same as the flat plate 124, is positioned immediately beneath the flat plate 124 surrounding the vertical post 120 to cushion against and prevent damage to the truck body sidewall 6, 8 when securing the sport equipment mount 10 to the truck body. Also included in the vertical post 120 is a through hole 128 used in securely affixing the sport equipment mount 10 to the truck body sidewall 6, 8.

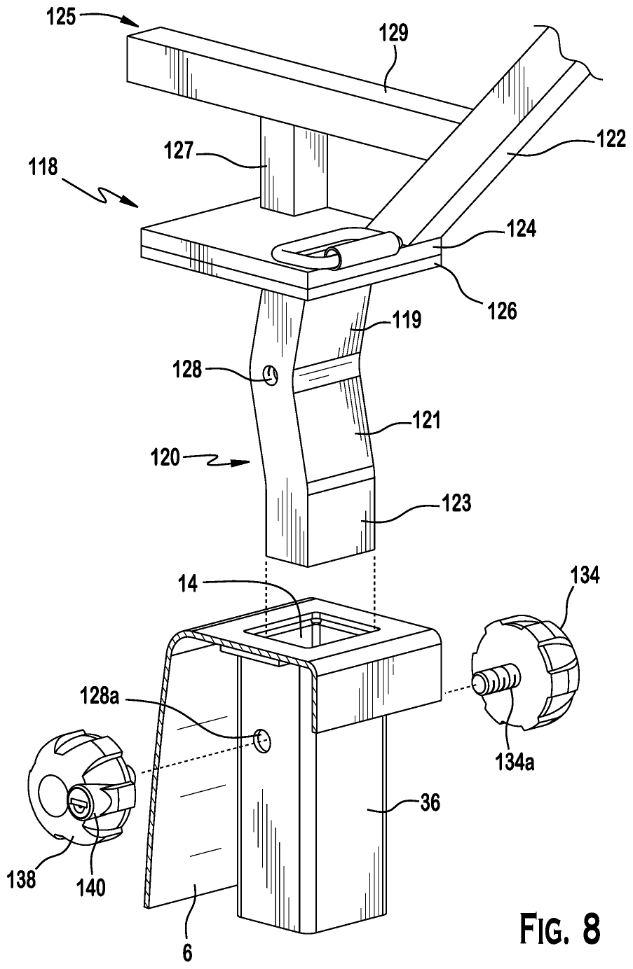

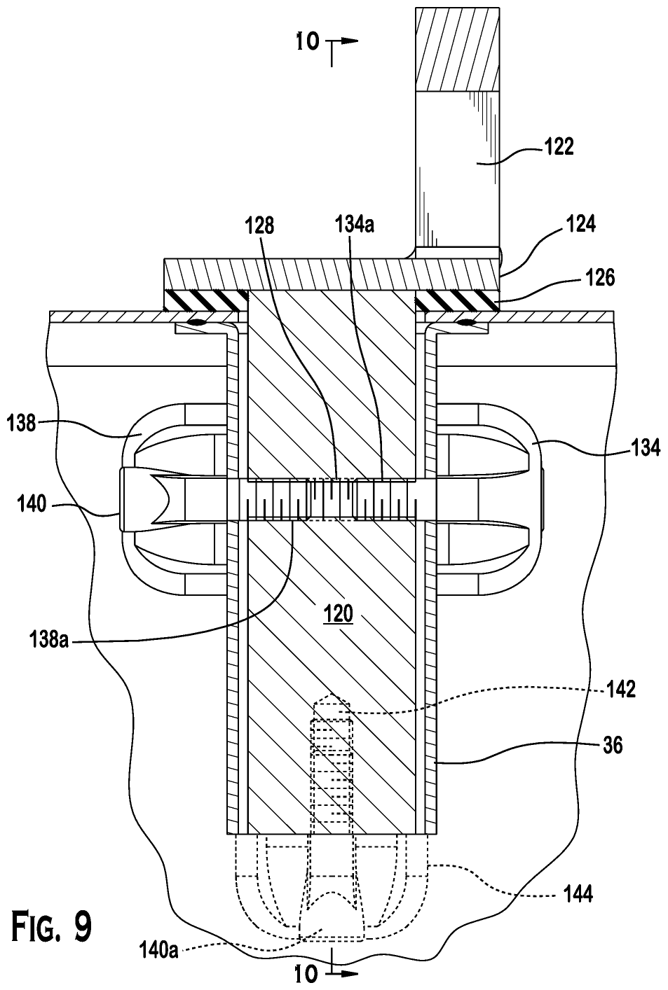

As shown in FIG. 8, in order to properly secure the vertical post 120 of the lower mounting section 118 of the sport equipment mount 10 into the post hole 14 a threaded knob 134 is inserted into positionally cooperative through hole 128a passing through the post hole wall 36 from front to back and through hole 128 of vertical post 120. The vertical post 120 of the lower mounting section 118 has an outwardly angled upper section 119, an inwardly angled middle section 121 and a vertical lower section 123 perpendicular to the flat plate 124. The angular offsetting of the upper and middle sections, 119, 121 respectively, of the vertical post 120 also serve to retain the lower mounting section 118 in the desired vertical orientation by offsetting any rotational forces due to loading of sport equipment 12 onto the extended length mounting post 122a.

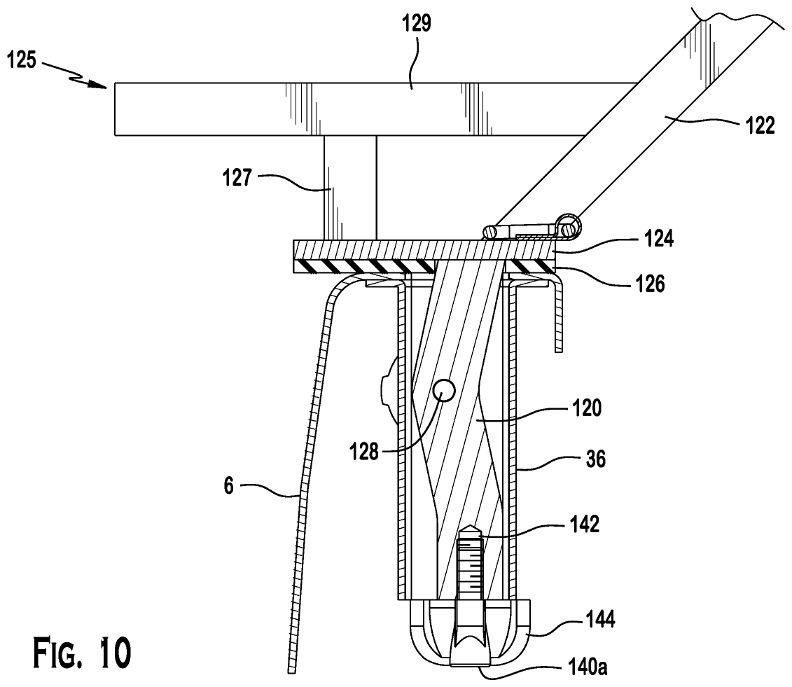

The threaded post 134a on the inward facing side of threaded knob 134 extends through both cooperating through holes 128, 128a and threadedly attaches to cooperating locking rear knob 138. Locking rear knob 138 has a keyway 140 used for locking the knob 138 against turning so as to guard against release or withdrawal of the vertical post 120 from the post hole 14 once secured and locked in position. Alternatively, the through hole 128 of a solid vertical post 120 can be threaded to accommodate the threaded extensions 134a, 138a of each of the securing knobs 134, 138. See, FIG. 9. Securing knob 138 will still maintain the keyway 140 for locking the knob 138 against turning to prevent removal of the vertical post 120 from the post hole 14. Further, the vertical post 120 may be alternately, or additionally secured into the post hole 14 by a bottom threaded hole 142 by an additional securing knob 144 and locking keyway 140a to prevent extraction of the lower mounting assembly, i.e., the vertical post 120, from the post hole 14 of the truck body. See, FIG. 10. A threaded rod 143 from knob 144 extends into threaded hole 142 to threadedly secure the knob 144 to the bottom of vertical post 120.

Referring back to FIG. 7, once the vertical post 120 is secured to the truck body the upper section 16 of the sport equipment mount 10 can then mounted to the mounting section 118, by mounting to either the lower mounting post 122 or to the extended length mounting post 122a, by means of a pair of clamps 30 and tightening knobs 32 that clamp inwardly onto the angled mounting post 122 or extended length mounting post 122a to securely retain the upper section 16 in the desired position along the length of the angled mounting post 122 or extended length mounting post 122a. The upper section 16 of the sport equipment mount 10 has at least one vertically oriented upwardly opening mounting slot 46 for accommodating a number of different sport equipment 12 such as snowboards, skis or larger sport equipment. In the present example there are shown two parallel slots 46 that have upper and lower cushions 48, 50, respectively, for assisting in retaining and guarding against damage to any carried sport equipment 12.

In the mounted position shown in FIG. 7 the upper section 16 for holding and carrying the sport equipment 12 is mounted bridging the junction of the angled mounting post 122 or extended length mounting post 122a. This position can be varied so that the angled mounting post 122 or extended length mounting post 122a can be adapted to carry and hold additional sport equipment 12 by positioning an additional upper section 16 of the sport equipment mount 10 along the angled mounting post 122 or extended length mounting post 122a so that at least two upper sections 16 can be mounted to the angled mounting post 122 and extended length mounting post 122a. In this manner any number of upper sections 16 can be mounted to the angled mounting post 122 and extended length mounting post 122a to accommodate additional sport equipment 12 with the only limitation being the length of the mounting posts and the density of the sport equipment 12 to be carried.

As described, the rack system for mounting sport equipment to the load bed side walls of a pickup truck, while maintaining access to the rack by a person located on the ground, provides for a plurality of rack mounting alternatives depending upon the type of sport equipment desired to be transported and used. When not in use, the rack system can be disassembled and removed from the side wall post holes and stored in the truck cab for later use. The upper section sport equipment mount is offered as only an example of the type of rack mount for specific equipment that can be used with the post hole lower mount and inwardly inclined mounting post. Any sport equipment rack system that mates securely to a rectangular post, by clamping or otherwise, can be utilized with this invention.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A sport equipment rack for mounting onto a vehicle load bed side wall comprising:
the vehicle load bed side wall having a plurality of mounting post holes located within the side walls and having a vertically distending shaft within the side walls;
a sport equipment rack mount having a support plate with a distending rectangular shaft dimensioned to fit within and be supported in a vertical orientation by a selected mounting post hole;
said sport equipment mount also including an inwardly angled upwardly extending rectangular shaft for supporting and retaining one or more sport equipment holders, whereby the sport equipment can be mounted to and removed from paired adjacent sport equipment holders by a sport equipment user standing at ground level.

2. The sport equipment rack of claim 1 further comprising an extension of the inwardly angled upwardly extending rectangular shaft for supporting and retaining additional sport equipment holders.

3. The sport equipment rack of claim 2 wherein the extension of the inwardly angled upwardly extending rectangular shaft for supporting and retaining additional sport equipment holders allows for one or more additional sport equipment holders to be mounted to said extending rectangular shaft.

4. The sport equipment rack of claim 1 wherein the inwardly angled upwardly extending rectangular shaft is preferred to have an inward angle of 45° such that the sport equipment held by the sport equipment mount to travel at a substantially vertical orientation.

5. The sport equipment rack of claim 1 further comprising one or more locking mechanisms paired with corresponding sport equipment mounts and mounting post holes that threadedly retain the sport equipment mount within the mounting post hole and guard against removal of the sport equipment mount with locking knobs preventing removal.

6. The sport equipment mount of claim 5 wherein the locking knobs connect through the sport equipment mount and the mounting post hole from a forward facing side to a rearward facing side.

7. The sport equipment mount of claim 6 wherein an additional locking knob connects the sport equipment mount and the mounting post hole from the mounting post hole bottom being threadedly connected through a hole in the post hole bottom into the sport equipment mount.

8. The sport equipment rack of claim 1 wherein the sport equipment mounts are positioned in desired mounting post holes in pairs depending upon the length of the sport equipment being transported.
